(19) United States
(12) Patent Application Publication
(10) Pub. No.: US 2013/0132704 A1
(43) Pub. Date: May 23, 2013

(54) MEMORY CONTROLLER AND METHOD FOR TUNED ADDRESS MAPPING

(71) Applicant: Frederick A. Ware, Los Altos Hills, CA (US)

(72) Inventor: Frederick A. Ware, Los Altos Hills, CA (US)

(73) Assignee: RAMBUS INC., Sunnyvale, CA (US)

(21) Appl. No.: 13/813,945

(22) PCT Filed: Aug. 29, 2011
(86) PCT No.: PCT/US11/49510

§ 371 Date: Feb. 2, 2013

Related U.S. Application Data
(60) Provisional application No. 61/381,730, filed on Sep. 10, 2010.

(51) Int. Cl. G06F 12/10

(52) U.S. Cl. CPC G06F 12/10
USPC 711/206

(57) ABSTRACT

A memory system maps physical addresses to device addresses in a way that reduces power consumption. The system includes circuitry for deriving efficiency measures for memory usage and selects from among various address-mapping schemes to improve efficiency. The address-mapping schemes can be tailored for a given memory configuration or a specific mixture of active applications or application threads. Schemes tailored for a given mixture of applications or application threads can be applied each time the given mixture is executing, and can be updated for further optimization. Some embodiments mimic the presence of an interfering thread to spread memory addresses across available banks, and thereby reduce the likelihood of interference by later- introduced threads.

### TECHNICAL FIELD

The present embodiments relate to techniques for saving power within memory systems.

### BACKGROUND

Advances in computing technology have benefitted from an exponential increase in the operating speed and complexity of integrated circuits (ICs). These increases have been accompanied by a corresponding increase in power consumption. Memory, ubiquitous in computer systems, is responsible for a considerable share.

Power consumption is, of course, generally undesirable due to the monetary and environmental costs associated with the creation, delivery, and storage of electricity. The energy-storage issue is particularly troublesome for mobile computing devices because the desired levels of processing power are incompatible with small, lightweight, and inexpensive batteries. There is therefore a demand for more efficient computing devices, which can be met in part by more efficient memories.

Dynamic Random Access Memory (DRAM) devices are common in computing systems, and may contribute to a notable portion of overall system power. DRAM power efficiency and speed performance have both improved dramatically over time, but these two important performance parameters are sometimes at odds. Some of the tension between speed performance and power efficiency stems from that way DRAM devices are organized.

DRAM devices are organized in uniquely addressed banks, rows, and columns When a processor seeks to read from a specified address, a memory controller translates the address into bits specifying the memory device, the bank within the device, and the row and column within the bank. These bits are then conveyed to the selected bank with signals specifying the desired memory operation. In response, the memory device activates the selected row in the selected bank, which moves stored information from the selected row into a set of sense amplifiers. The column bits are then used to select a subset of the bits stored in the row buffer. A given row might support e.g., 256 columns Because the row is stored in the set of sense amplifiers, other subsets of the same row can be accessed very quickly. In other words, successive accesses to the same row can exploit “spatial locality” to improved speed performance.

Typically, only a single row in a given bank can be accessed at a time. As compared with successive accesses to the same row, switching between rows in the same bank takes considerably longer. That is, accesses to different rows in the same bank—sometimes referred to as “row-buffer conflicts”—consume time and power, and are therefor undesirable.

### BRIEF DESCRIPTION OF THE FIGURES

The subject matter disclosed is illustrated by way of example, and not by way of limitation, in the figures of the accompanying drawings and in which like reference numerals refer to similar elements and in which:

FIG. 1 depicts a computer system 100 in which physical addresses are mapped to memory device addresses in a way that reduces power consumption. FIG. 2 is a flowchart 200 illustrating the operation of a memory controller in system 100 of FIG. 1 in accordance with one embodiment.

FIG. 3A is a timing diagram illustrating how a series of read transactions, as issued by a memory controller, may be spread across four banks (Bank[3:0]) of a memory device to avoid bank conflicts, and to therefore improve memory access latency by interleaving accesses among the banks.

FIGS. 3B is a timing diagram illustrating how a memory controller can extract from memory the same amount of data read in FIG. 3A just as quickly using less energy.

FIG. 4 is depicts a memory system 400 in accordance with an embodiment that supports partial-array self-refresh (PASR).

FIG. 5 details logic 430 of FIG. 4 in accordance with one embodiment. Logic 430 includes logic gates that are well understood by those of skill in the art.

FIG. 6 shows a flowchart 600 illustrating the workings of one embodiment of memory system 400 of FIG. 4.

FIG. 7 is depicts a mapping scheme 700 in accordance with another embodiment. Physical and device addresses APHY and Dadd are divided as into various address fields as described above in connection with FIG. 4.

FIG. 8 details logic 730 of FIG. 7 in accordance with one embodiment.

FIG. 9 is a diagram 900 illustrating the mapping between virtual and physical page addresses in accordance with one example consistent with the operation of the memory systems detailed previously.

FIG. 10 shows an address-translation scheme in accordance with an embodiment that supports different page sizes.

FIG. 11 shows a flowchart 1100 illustrating the workings of another embodiment of memory system 100 of FIG. 1 using the mapping scheme illustrated and described in connection with FIG. 4.

### DETAILED DESCRIPTION

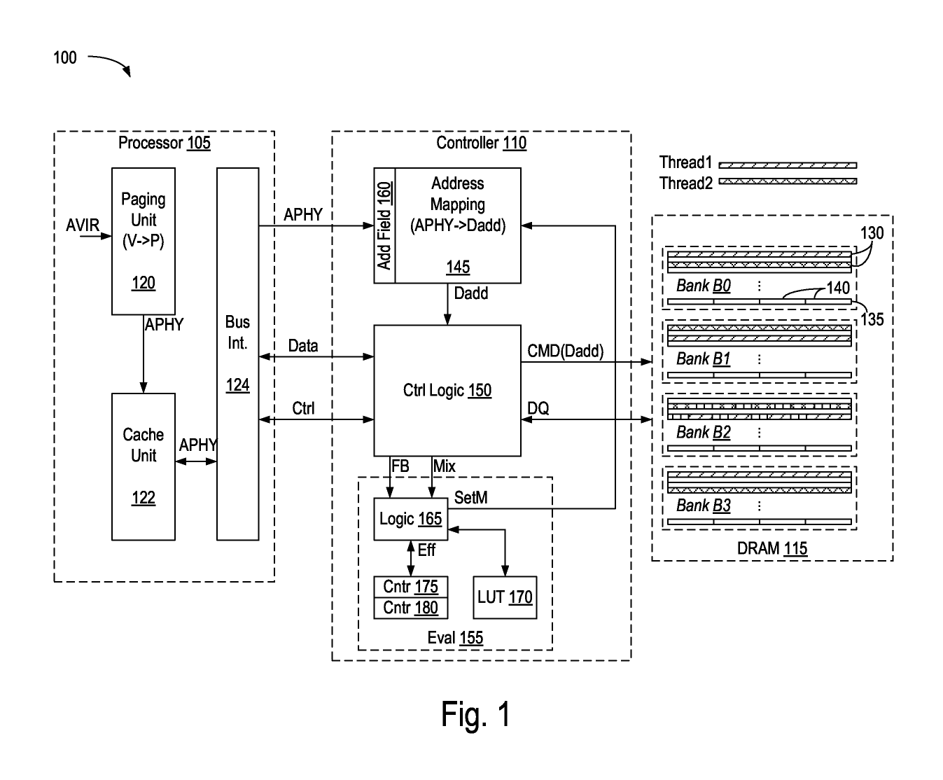

FIG. 1 depicts a computer system 100 in which physical addresses are mapped to memory device addresses in a way that reduces power consumption. System 100 includes circuitry for deriving efficiency measures for memory usage and selects from among various address-mapping schemes to improve efficiency. The address-mapping schemes can be tailored for a given memory configuration or a specific mixture of active applications or application threads. Schemes tailored for a given mixture of applications or application threads can be applied each time the given mixture is executing, and can be updated for further optimization. As used herein, a “thread” is the smallest unit of processing that can be scheduled by an operating system.

System 100 includes a processor 105, a controller 110, and a dynamic random-access memory (DRAM) device 115. Controller 110 supports dynamic address-mapping schemes that reduce power usage. In some embodiments, different mapping schemes can be used for different combinations of executing applications or application threads.

Processor 105 includes a paging unit 120, a cache unit 122, and a bus interface 124. Paging unit 120 converts virtual addresses AVIR to physical addresses APHY, which are then temporarily stored in cache unit 122. Bus interface 124 communicates physical addresses APHY, as well as data and control signals Data and Ctrl, to controller 110.

In operation, processor 105 sends requests, or commands, to controller 110 via control bus Ctrl. These requests can include or be associated with a physical address APHY that specifies the target of the request. For example, a read request might specify an address from which to read the requested data. Controller 110 queues and orders such requests, and reformats and times them as appropriate for DRAM 115. Though shown as separate components, the functionality provided by processor 105 and controller 110 can be integrated into a single device. The operation of processor 105 is conventional, and its operation is well known to those of skill in the art. A detailed discussion of the workings of processor 105 is therefore omitted for brevity.

In an embodiment, DRAM 115 includes four memory banks B[3:0], each of which includes a number of rows 130 and a collection of sense amplifiers 135. Each collection of sense amplifiers 135 is, in turn, divided into subsets 140 that are separately addressable using column address bits. Different rows in each bank are cross-hatched differently to represent information from different process threads (Thread1 and Thread2) simultaneously occupying DRAM 115. While only four rows 130 and sense-amplifier subsets 140 are shown, practical embodiments include many more. DRAM 115 is conventional, and its operation is well known to those of skill in the art. A detailed discussion of the workings of DRAM 115 is therefore omitted for brevity.

Controller 110 includes address mapping unit 145, control logic 150, and evaluation circuitry 155. Mapping unit 145 receives physical addresses APHY from processor 105 as address fields 160 and converts them into device addresses Dadd. Control logic 150 interacts with DRAM 115 responsive to control signals on bus Ctrl. Responsive to a write request, for example, control logic 150 converts the physical address in field 160 into a device address Dadd that includes address bits specifying a bank, row, and column in DRAM 115. If DRAM 115 includes more than one device (e.g., multiple memory devices organized in ranks), control logic 150 can also derive a chip-select signal from the physical address to select from among the devices. Control logic 150 then creates a command CMD that includes the device address and that stimulates DRAM 115 to respond to the request from processor 105.

In the case of a read or write request to bank B0, for example, command CMD causes DRAM 115 to activate a row specified by a row address. DRAM responds by conveying the contents of the row to the associated sense amplifiers 135. A column command, and a corresponding column address, selects access of data latched in one of sense-amplifier subsets 140. In the case of a read request (or command), the contents of the selected sense amplifier subset is accessed and conveyed, via the DRAM interface, to controller 110 via data bus DQ. For a write operation, the selected sense amplifier subset 140 is overwritten.

In addition to handling requests as outlined above, controller 110 can adjust mapping unit 145 to select between alternative address-mapping schemes based on measures of power efficiency. Feedback FB from control logic 150 allows evaluation circuitry 155 to derive measures of power efficiency for the operation of system 100. Evaluation circuitry 155 issues mapping instructions SetM to address mapping unit 145 based on these performance metrics, and in this way settles upon an address-mapping solution that reduces power consumption.

Different mixtures of applications and application threads may benefit from different address-mapping solutions. Control logic 150 therefore provides a signal Mix specifying the mixture of applications and application threads for which information is resident in DRAM 115. Logic 165 within evaluation circuitry 155 can associate a given mix with a preferred address-mapping solution and store the results in a look-up table (LUT) 170. Storing these correlations in LUT 170 allows controller 110 to quickly select previously determined preferred mapping schemes.

Evaluation circuitry 155 measures power efficiency by calculating the average energy use per memory access for a given mapping scheme. In this example, feedback signal FB allows logic 165 to accumulate, in respective counters 175 and 180, the number of memory transactions and the number of row-activate commands issued to a memory device during a given test interval. Row-activate commands move an entire row of data to and from one of the collections of sense amplifiers 135, which is relatively energy intensive. By contrast, successive accesses to the same row can be accomplished by merely reading from or writing to selective ones of sense amplifier subsets 140. The lower the ratio of row-activate commands to memory accesses, the more efficient the address mapping. Controller 110 can try a number of mapping schemes to arrive at a preferred setting, and can tailor such settings for specific applications, or for mixtures of threads.

FIG. 2 is a flowchart 200 illustrating the operation of a memory controller in system 100 of FIG. 1 in accordance with one embodiment. In particular, flowchart 200 illustrates how controller 110 arrives at a preferred address-mapping scheme in one embodiment. The process starts with some mapping M, the setting of which is designated M=0 in 205. Next, as the threads are executing, address mapping unit 145 converts physical addresses in field 160 into device addresses Dadd for application to DRAM 115 (210). Processor 105 executes the threads (215) as evaluation circuitry 155 uses feedback signal FB to measure average access energy AE (220). Logic 165 stores this measure of access energy in LUT 170 in association with the mapping setting (225).

At some point the memory controller in system 100 is powered down. As part of the power-down procedure, the information in LUT 170 is moved into non-volatile memory, such as flash (230). When next powered up (235), in decision 240 logic 165 checks whether all of the mapping possibilities have been exhausted. If not, the address-mapping setting M is incremented (245) and the process returns to 210. The foregoing process is then repeated for the next mapping. If all the mappings have been explored, logic 165 selects the mapping setting Mbest that provided the lowest access energy (250) and issues an instruction SetM to mapping unit 145 to use this setting. Mapping unit 145 then maps physical addresses APHY to device addresses Dadd using the preferred mapping scheme Mbest (255).

The process of flowchart 200 can be repeated periodically. Further, a preferred mapping can be determined for different combinations of process threads, and LUT 170 can be used to look up a preferred setting for a given mix of threads. Preferred mapping schemes can also be found for other scenarios that might impact the mix of threads and applications residing in memory. For example, the mix of threads might change consistently with time of day, day of the week, device location, or device movement. For example, a device might be expected to execute threads associated with certain productivity applications during working hours, video and gaming applications after work or on weekends, and telephony and GPS applications while under way.

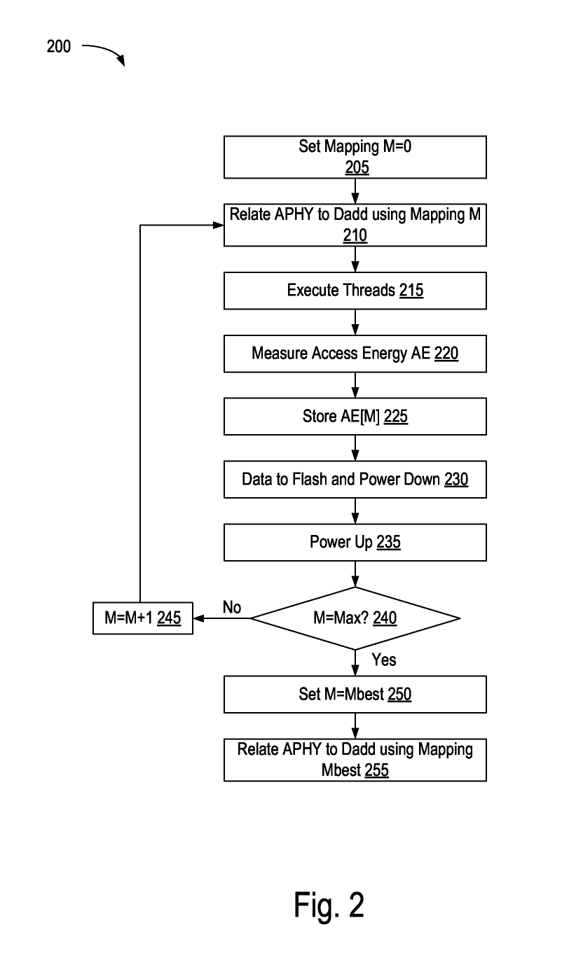

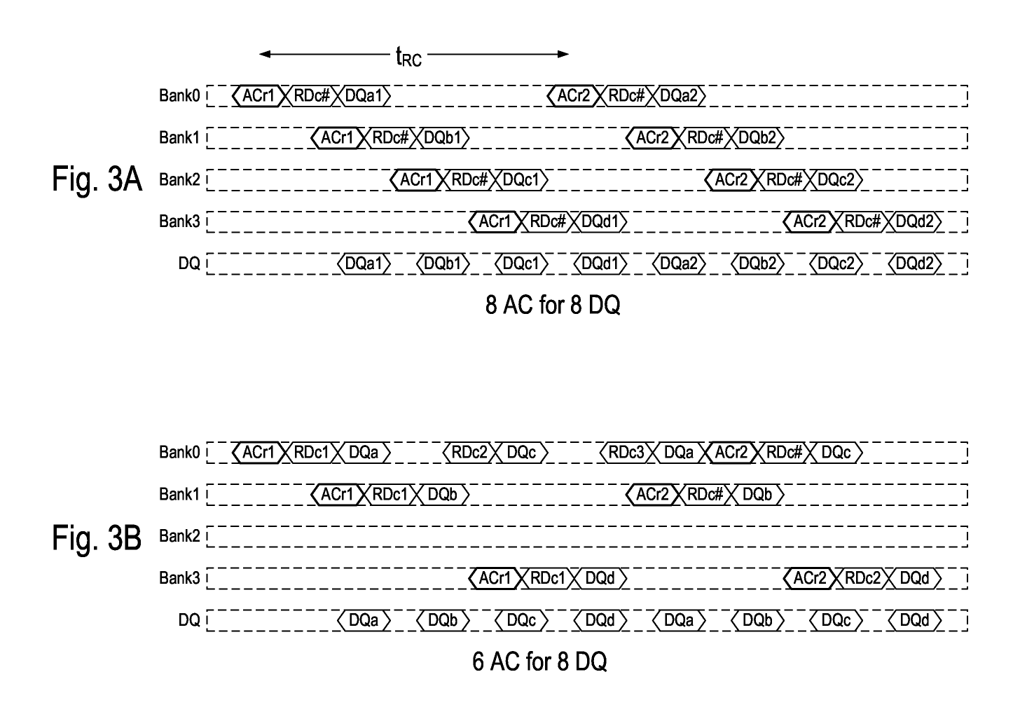

FIG. 3A is a timing diagram illustrating how a series of read transactions, as issued by a memory controller, may be spread across four banks (Bank[3:0]) of a memory device to avoid bank conflicts, and to therefore improve memory access latency by interleaving accesses among the banks. In the top row, the controller issues an access command (herein also referred to as activate commands) specifying row one of bank Bank0 followed by a read command RDc# to a specified column in the same bank. The data DQa1 stored at the specified address is then made available on the data interface DQ of the memory device, which is then received by an interface of the controller device. Next, after a minimum row cycle time t_{RC}, the controller issues a second access command ACr2 specifying a different row (row two) of the same bank Bank0 followed by a read command RDc# to a specified column in the same bank. The data DQa2 stored at the specified address is then made available on the data interface DQ.

The row cycle time t_{RC} limits the speed of back-to-back reads to different rows of the same bank. One approach to better utilize memory resources is to interleave memory accesses across banks, as shown, so that the resulting data can be spaced closely on the data channel DQ. Closely spacing data on interface DQ maximizes the use of the data bus, and consequently optimizes speed performance. Unfortunately, spreading of the data across banks tends to increase the number of row access operations, which as noted above are relatively energy intensive. In the instant example, eight accesses are employed to read eight collections of data.

FIGS. 3B is a timing diagram illustrating how a memory controller can extract from memory the same amount of data read in FIG. 3A just as quickly using less energy. The memory controller allocates the data across the banks to take advantage of the principle of data locality. That is, the proportion of back-to-back accesses to the same row of the same bank is increased to increase the probability of a row “hit,” in which case a single row access can provide multiple collections of data. In the example of FIG. 3B, the memory controller only initiates six row accesses to read the same eight collections of data read in the example of FIG. 3A.

The reduction from eight to six row accesses represents a considerable energy savings. In this example, this energy savings occurs without a performance penalty, though this may not always be the case. In general, however, controller 110 selects mapping schemes that maximize row hits (i.e., accesses to a row for which data is already present in the associated sense amplifiers). As compared with conventional approaches that tailor mapping to spread accesses across banks, emphasizing page hits is less likely to optimize data-bus usage. This potential disadvantage is offset by reduced power usage, however, for some applications. In other embodiments different mapping schemes can be used depending upon whether the user favors speed performance over power savings. This preference can be general, or can be specific to a given operational environment. Memory access speed might be the preferred performance metric when the memory system is provided with external power, for example.

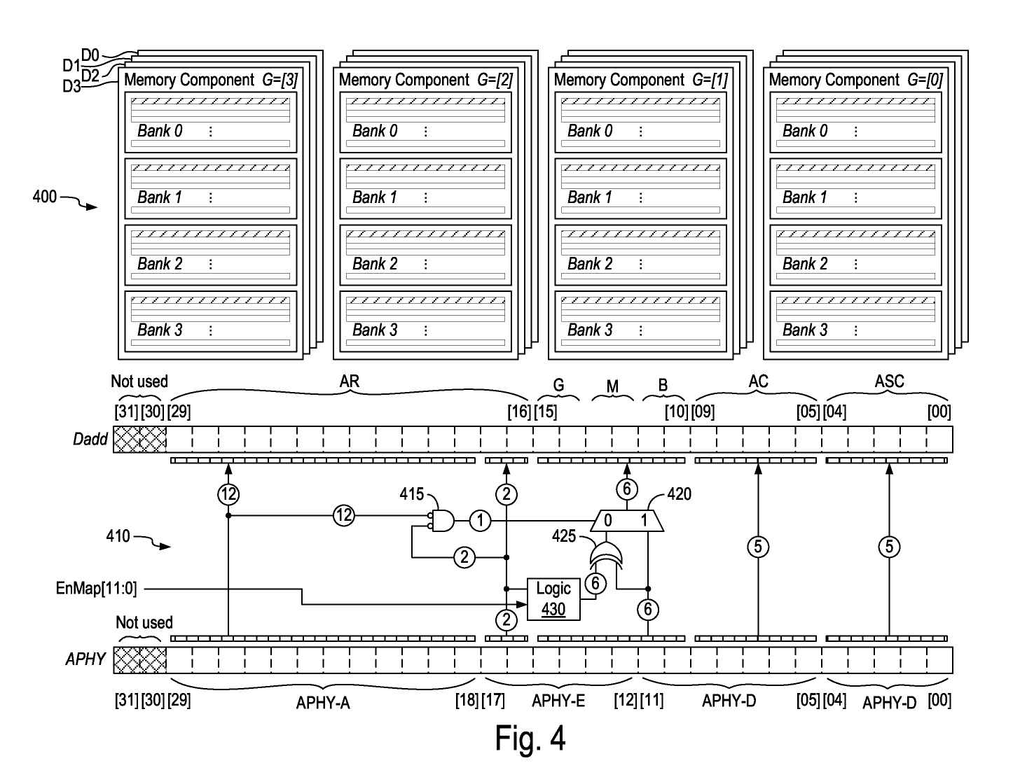

FIG. 4 is depicts a memory system 400 in accordance with an embodiment that supports partial-array self-refresh (PASR). PASR is an operational mode in which refresh operations are not performed across the entire memory, but are instead limited to specific banks where data retention is required. Data outside of the sensitive portion of the memory is not retained, and the resulting reduction in refresh operations saves power. For example, PASR may be used to refresh a subset of memory rows used to respond to baseband memory requests required to maintain connectivity to a local cellular network while other functionality is inactivated to preserve power.

Memory system 400 includes groups of memory components, also referred to as memory devices or just devices. Each group of memory components is organized as one of ranks G[3:0]. Each component, in this example, includes four memory banks Bank[3:0]. In this example, it is assumed that one row in each bank, highlighted using shading, is always unmapped. Bits Dadd[29:16] of the device address for these unmapped rows is all zeros in this embodiment (i.e., field AR is all zeros=000 . . . 000). The unmapped rows provide a place to leave code and data during a low-power state, during which time the code and data in the other rows in each bank are written to non-volatile storage (Flash, for example). Also in the low-power state, the unmapped row in each bank is refreshed, e.g. with self-refresh circuitry, to maintain the code and data stored therein. When the system returns to normal activity, the mapping function can be changed before code and data are re-loaded into the mapped rows. The mapped rows can be a relatively small subset of the total amount of memory. In one embodiment, for example, there are 4,095 mapped rows for each unmapped row. Different mapping functions can be tried for the mapped rows to find mapping functions that provide improved efficiency, either generally or for particular mixes of applications or threads, or for different operational environments. In other embodiments other subsets of memory can be selectively saved when in low-power states.

The lower portion of FIG. 4 depicts how physical addresses APHY are mapped to devices address Dadd and vice versa in this embodiment. Physical addresses APHY are divided into various address fields. These are physical address fields APHY-A, APHY-E, and APHY-D, the last of which is further divided into subsets APHY[11:05] and APHY[04:00]. Device addresses Dadd are likewise divided into various fields, albeit somewhat different ones. These fields are AR, G, M, B, AC, and ASC.

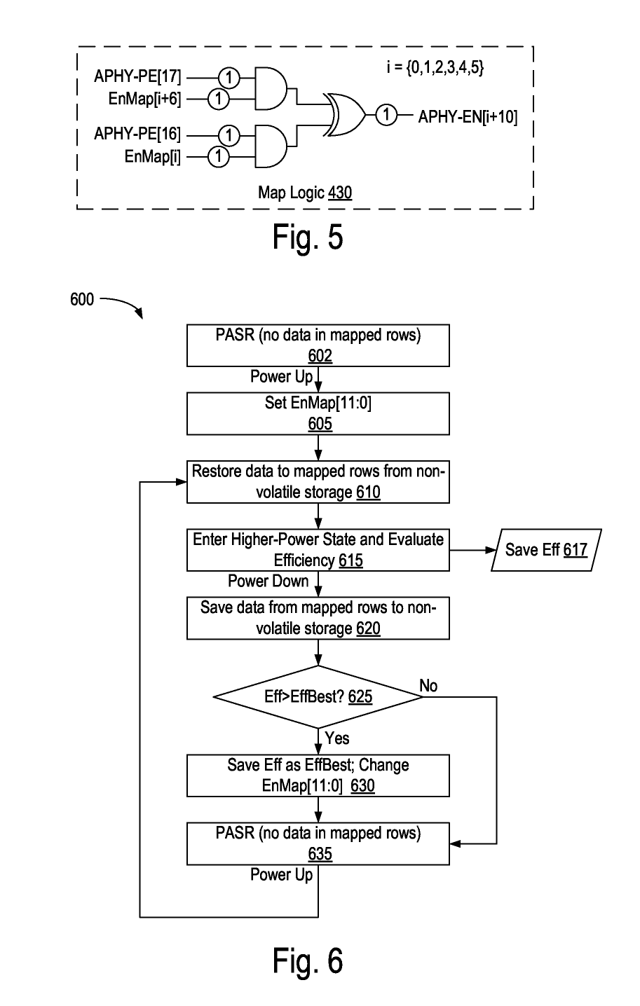

Memory system 400 includes mapping logic 410 to map physical-address bits APHY[15:10] to device-address bits Dadd[15:10]. Mapping logic 410 accomplishes this address mapping using an AND gate 415, a multiplexer 420, an XOR gate 425, and some additional logic 430 to be detailed later in connection with FIG. 5. With reference to FIG. 1, mapping logic 410 is part of address mapping unit 145 within controller 110 in one embodiment.

AND gate 415 performs a logical not-and of the fourteen row-address bits APHY-A; namely, when bits APHY[29:16] are all zeros, the output of AND gate 415 is a logic one, in which case the bits of address APHY are mapped directly to the same bit locations of device address Dadd. When bits APHY[29:16] are not all zeros, the output of AND gate 415 is a logic zero, in which case multiplexer 420 remaps bits APHY[15:10] to bits Dadd[15:10]. In this remapping, logic 430 combines map-enable signal EnMap[11:0] with bits APHY[17:16] as detailed later, and XOR gate 425 selectively inverts bits of physical address APHY[15:10].

FIG. 5 details logic 430 of FIG. 4 in accordance with one embodiment. Logic 430 includes logic gates that are well understood by those of skill in the art. A detailed discussion of how these gates logically combine the input signals to logic 430 is therefore omitted for brevity.

FIG. 6 shows a flowchart 600 illustrating the workings of one embodiment of memory system 400 of FIG. 4. The process begins at 602, at which time memory system 400 is in a low-power state in which some set of minimum functionality may find support in unmapped rows in memory system 400. When the controller lifts the memory from the low-power state, the memory controller sets map-enable signal EnMap[11:0] to some value (605), and loads data and instructions from non-volatile memory (e.g., Flash) into memory system 400 at locations determined by mapping logic 410 (610). The efficiency of memory system 400 using the selected mapping is then evaluated (615) as explained previously, and a measure of this efficiency is stored (617). Then, when a power-down signal is received, the memory controller directs the memory to store data from the mapped rows to non-volatile memory (620) for later use.

If the measured efficiency is improved over either prior measurements or some initialized value EffBest (decision 625), than the new efficiency value Eff is recorded as EffBest and a new map setting EnMap[11:0] is selected for evaluation (630). Memory system 400 then enters the PASR mode, in which no data is present in the mapped rows (635). The process of flowchart 600 repeats for different mappings to find ones that provide relatively good power efficiency. In some embodiments address mappings are related to the mix of applications for which instructions reside in memory system 400 so that mappings can be tailored to minimize bank interference between applications to be measured across real platform workloads.

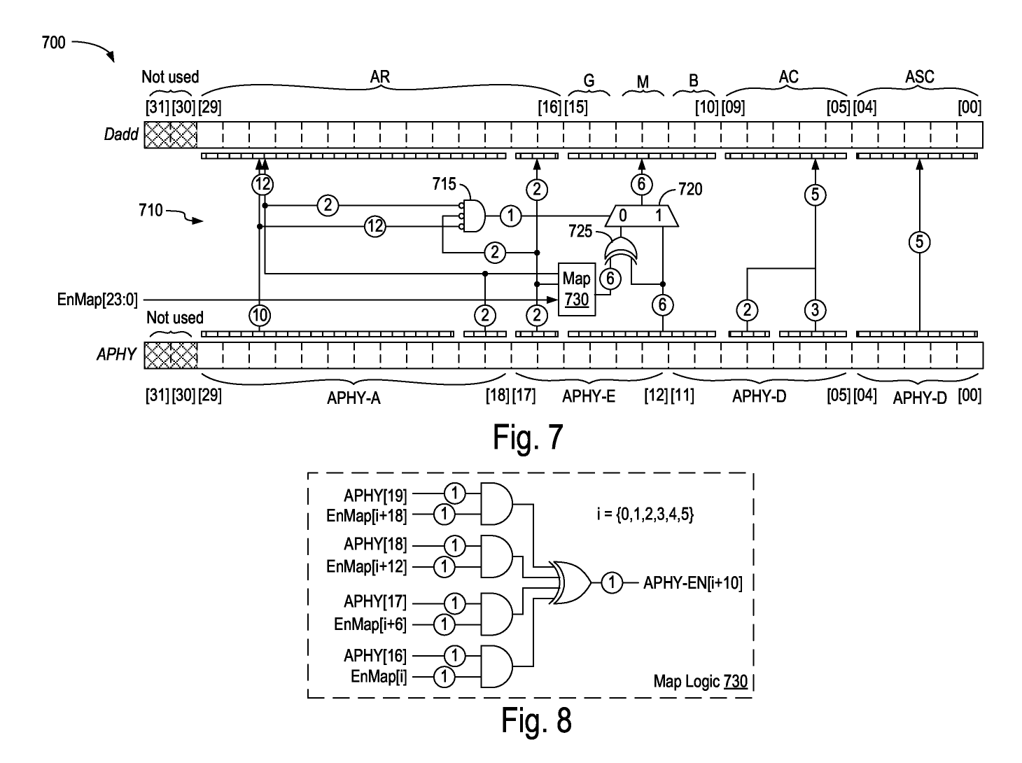

FIG. 7 is depicts a mapping scheme 700 in accordance with another embodiment. Physical and device addresses APHY and Dadd are divided as into various address fields as described above in connection with FIG. 4. System 700 includes mapping logic 710 to map physical to device addresses. This remapping applies to physical-address bits APHY[15:10], which are remapped to device-address bits Dadd[15:10]. Mapping logic 710 includes an AND gate 715, a multiplexer 720, an XOR gate 725, and some additional logic 730 to be detailed later in connection with FIG. 8.

AND gate 715 performs a logical not-and of the fourteen row-address bits APHY-A (APHY[29:16]); namely, when bits APHY[29:16] are all zeros, the output of AND gate 715 is a logic one, in which case the bits of address APHY are mapped directly to the same bit locations of device address Dadd. When bits APHY[29:16] are not all zeros, the output of AND gate 715 is a logic zero, in which case multiplexer 720 remaps bits APHY[15:10] to bits Dadd[15:10]. In this remapping, logic 730 combines map-enable signal EnMap[23:0] with bits APHY[17:16] as detailed later, and XOR gate 725 selectively inverts bits of physical address APHY[15:10].

FIG. 8 details logic 730 of FIG. 7 in accordance with one embodiment. Logic 730 includes logic gates that are well understood by those of skill in the art. A detailed discussion of how these gates logically combine the input signals to logic 730 is therefore omitted for brevity.

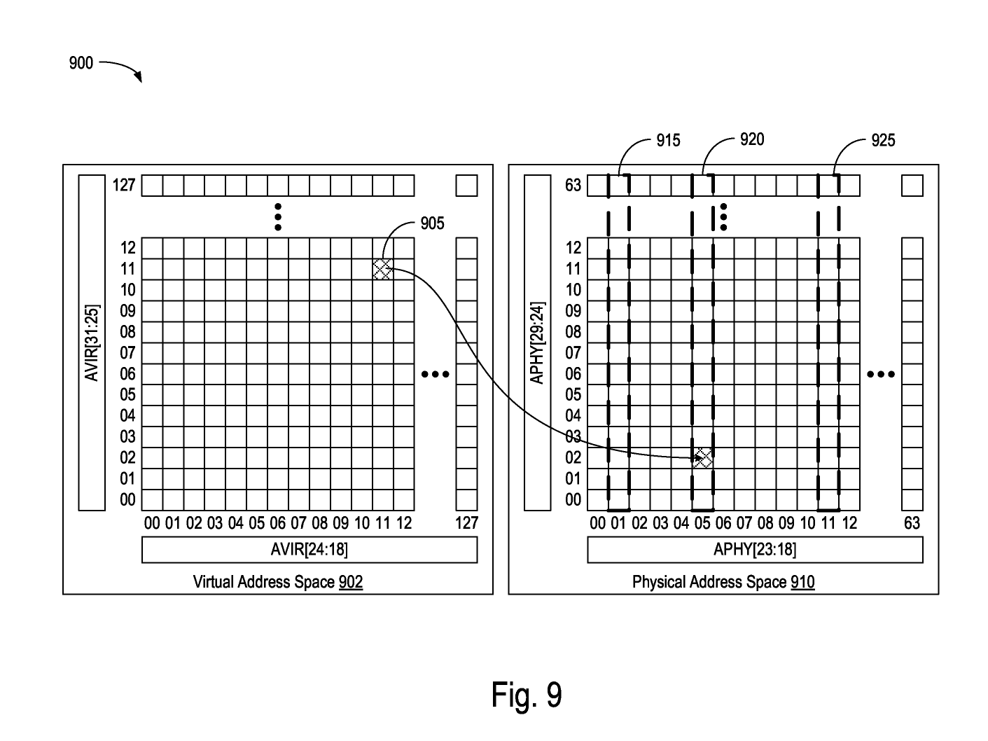

FIG. 9 is a diagram 900 illustrating the mapping between virtual and physical page addresses in accordance with one example consistent with the operation of the memory systems detailed previously. On the left, a two-dimensional array 902 represents virtual address space, with the intersection of each row and column identifying a virtual page of e.g. sixteen kilobytes of storage. One page 905, highlighted by shading, include a tag entry indicating that address bits APHY[19:18] (see FIG. 7) must be “01”. These two bits represent the low-order physical page address bits, which if kept constant for a particular page can contribute to the mapping process for memory-bank address fields. On the right of FIG. 9, a two-dimensional array 910 represents physical address space, with the intersection of each row and column identifying a physical page.

In this example, holding the two low-order address bits constant during address translation requires the address-mapping scheme to place the information at page 905 into one of columns 915, 920, and 925 in the physical space. Paging software can impose this requirement by making physical address bits APHY[19:18] equal to virtual address bits AVIR[19:18] for each page and including a corresponding tag entry in the paging tables and translation look-aside buffer (TLB) in each processor. A virtual page at address AVIR[31:18] can thus be placed at different physical page locations within physical addresses APHY[29:18]. Because the low-order virtual address bits AVIR[17:0] are copied directly across to physical-address bits APHY[17:0], mapping logic 730 can adjust the bank used by a particular row according to a preferred mapping function.

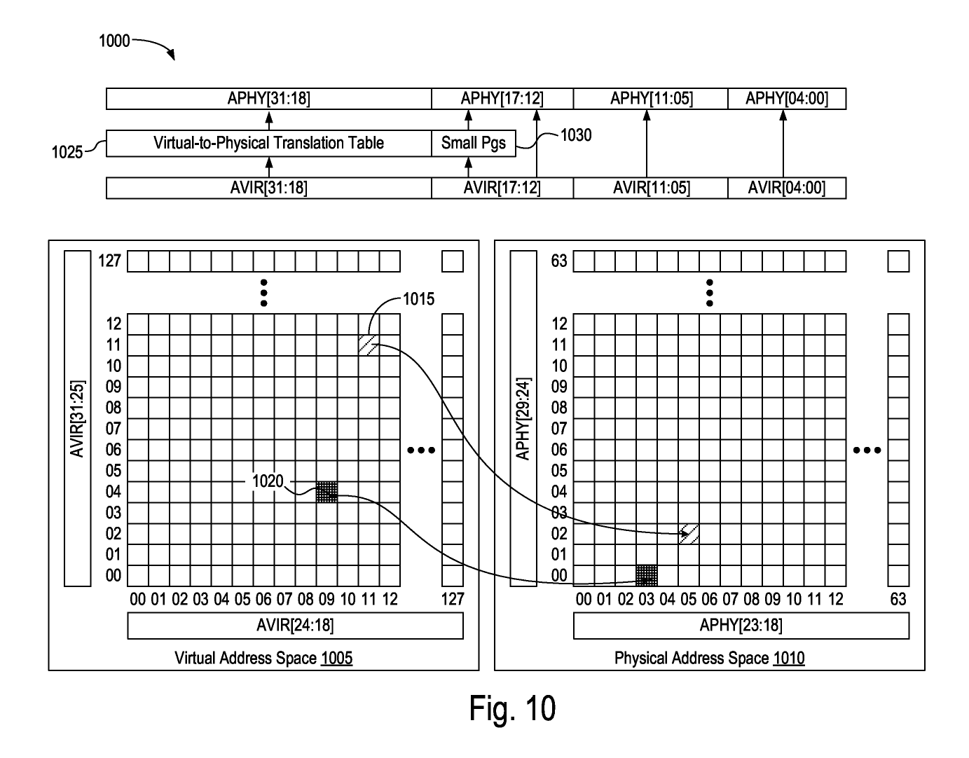

FIG. 10 shows an address-translation scheme in accordance with an embodiment that supports different page sizes. A diagram 1000 shows how virtual addresses AVIR[31:00] are mapped to physical addresses APHY[31:00], while a pair of arrays 1005 and 1010 represent virtual and physical address space, respectively. This embodiment simultaneously supports relatively large, 256 KB pages 1015, and smaller 4 KB pages 1020. For example, a four gigabyte virtual memory space might support a million 4 KB pages, sixteen thousand 256 KB pages, or a combination of pages of each size, and can be used in conjunction with a one gigabyte physical memory that supports 256 4 KB pages, four thousand 256 KB pages, or a combination of pages of each size.

The address translation of diagram 1000 shows how the system allows different page sizes to coexist in the same virtual and physical address spaces. A first table 1025 translates the fourteen most significant virtual address bits AVIR[31:18] to corresponding physical address bits, and does so for both large and small pages. A second table 1030 translates virtual address bits AVIR[17:12] to the corresponding physical address bits APHY[17:12], but does so only for the smaller pages. From an addressing perspective, each small page is a one of a collection of small pages defined within a larger page. The small pages within each large page will share the same address tag information, and will typically require a presence bit and a dirty bit per small-page entry.

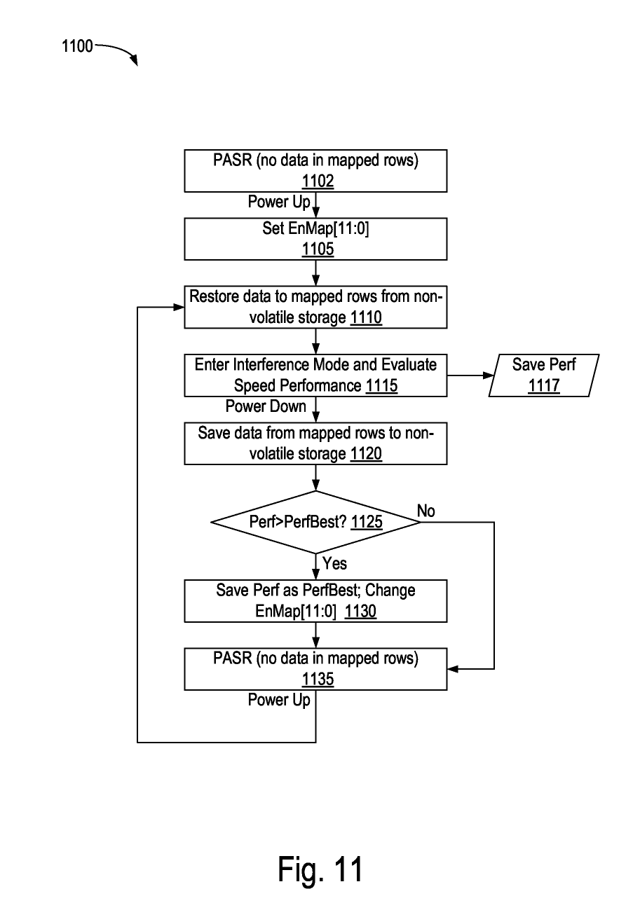

FIG. 11 shows a flowchart 1100 illustrating the workings of another embodiment of memory system 100 of FIG. 1 using the mapping scheme illustrated and described in connection with FIG. 4. In this embodiment, rather than focusing on power savings, controller 110 supports a calibration mode that optimizes address mapping to reduce the performance impact of interfering threads in DRAM 115. While executing a thread or combination of threads, controller 110 mimics the presence of an interfering thread by responding to page hits as though they were page misses. These simulated misses cause controller 110 to reactivate the target row and await the loading of data into the sense amplifiers, and thus slow memory performance. Controller 110 then adjusts its memory address mapping to reduce the number of such simulated page misses, and thereby spreads the memory addresses employed by the thread or threads in DRAM 115 across the available banks. Threads later introduced into DRAM 115 along with the thread or threads used to calibrate the mapping scheme are thereafter less likely to interfere.

In some embodiments the performance metric is based on the average number of wait cycles per transaction; if a transaction is forced to artificially page-miss, wait cycles are introduced into the data stream, or the memory controller can schedule another transaction earlier to use the wait cycles. This requires the measurement hardware classify the data stream into data cycles, wait cycles (a wait cycle occurs when there is not data on the data bus and there is/are pending transaction/s), and idle cycles (an idle cycle occurs when there is not data on the data bus and there are no pending transactions).

The memory need not perform an activate/precharge operation for an artificial page-miss, but it does insert the tRCD/tRDP/tWRP delays into the command stream as if the operations were being performed. This will open up gaps on the data bus which the memory controller will try to fill by moving other transactions earlier.

The process begins at 1102, at which time the memory system is in a low-power state. When the controller lifts the memory from the low-power state, the memory controller sets map-enable signal EnMap[11:0] to some value (1105), and loads data and instructions from non-volatile memory (e.g., Flash) into memory system 400 at locations determined by mapping logic 410 (1110). The speed performance of memory system 400 using the selected mapping is then evaluated based upon the assumption that both page hits and page misses represent page misses (1115). In one embodiment, for example, speed performance is a measure of the ratio of row-activate request to the sum of real and simulated page misses. In other embodiments only simulated misses are used for this calculation, and other performance metrics might also be used to derive a proportion of row hits. However calculated, controller 110 stores this performance measure Perf in DRAM 115 or elsewhere (1117). Then, when a power-down signal is received, the memory controller directs the memory to store data from the mapped rows to non-volatile memory (1120) for later use.

If the measured performance Perf is improved over either prior measurements or some initial value EffPerf (decision 1125), than the new performance value Perf is recorded as PerfBest and a new map setting EnMap[11:0] is selected for evaluation (1130). Memory system 400 then enters the PASR mode, in which no data is present in the mapped rows (1135). The process of flowchart 1100 repeats for different mappings to find ones that provide relatively high performance for an executing application or combination of applications. In some embodiments address mapping schemes are related to the mix of applications for which instructions reside in memory system 400 so that mappings can be tailored accordingly.

An output of a process for designing an integrated circuit, or a portion of an integrated circuit, comprising one or more of the circuits described herein may be a computer-readable medium such as, for example, a magnetic tape or an optical or magnetic disk. The computer-readable medium may be encoded with data structures or other information describing circuitry that may be physically instantiated as an integrated circuit or portion of an integrated circuit. Although various formats may be used for such encoding, these data structures are commonly written in Caltech Intermediate Format (CIF), Calma GDS II Stream Format (GDSII), or Electronic Design Interchange Format (EDIF). Those of skill in the art of integrated circuit design can develop such data structures from schematic diagrams of the type detailed above and the corresponding descriptions and encode the data structures on computer readable medium. Those of skill in the art of integrated circuit fabrication can use such encoded data to fabricate integrated circuits comprising one or more of the circuits described herein.

While the present invention has been described in connection with specific embodiments, variations of these embodiments will be obvious to those of ordinary skill in the art. Moreover, some components are shown directly connected to one another while others are shown connected via intermediate components. In each instance the method of interconnection, or “coupling,” establishes some desired electrical communication between two or more circuit nodes, or terminals. Such coupling may often be accomplished using a number of circuit configurations, as will be understood by those of skill in the art. Therefore, the spirit and scope of the appended claims should not be limited to the foregoing description. Only those claims specifically reciting “means for” or “step for” should be construed in the manner required under the sixth paragraph of 35 U.S.C. §112.

What is claimed is:

1. A method of operation in a memory controller, the method comprising:
relating a physical-address field to memory-device addresses using a first mapping;
measuring a first access energy associated with the first mapping;
relating the physical-address field to the memory-device addresses using a second mapping;
measuring a second access energy associated with the second mapping; and
selecting between the first and second mappings based upon the first and second access energies.

2. The method of claim 1, wherein measuring the first access energy includes determining a ratio of row-activate commands to memory transactions.

3. The method of claim 1, further comprising translating physical addresses in the physical-address field to the memory-device addresses according to the first and second mappings.

4. The method of claim 3, further comprising translating virtual addresses to the physical addresses in the physical-address field, the translating including copying portions of the virtual addresses into a subfield of the physical-address field.

5. The method of claim 4, wherein the first and second mappings apply only to the subset of the physical-address field.

6. The method of claim 1, wherein the memory-device addresses are a subset of a total number of available memory-device addresses, and wherein the first and second mappings apply only to the subset of the total number.

7. The method of claim 1, further comprising storing data from the memory-device addresses in non-volatile memory using the first mapping.

8. The method of claim 7, further comprising writing the data from the non-volatile memory to the memory-device addresses using the second mapping.

9. The method of claim 1, further comprising executing multiple processes across the memory device addresses while measuring the first and second access energies.

10. The method of claim 9, further comprising relating the multiple processes, as a combination of processes, to the first and second access energies.

11. The method of claim 10, further comprising relating a second combination of processes to second access energies.

12. The method of claim 11, further comprising selecting between the first and second mappings based upon the first and second access energies and execution of the first-mentioned combination of processes.

13. A method of operation in a memory controller, the method comprising:
relating a physical-address field to memory-device addresses using a first mapping and a second mapping;
mapping a first combination of processes across the memory-device addresses using the first and second mappings;
measuring first and second performance metrics associated with the first combination of processes and the respective first and second mappings;
selecting between the first and second mappings for the first combination of processes based upon the first and second performance metrics;
relating the physical-address field to the memory-device addresses using a third mapping and a fourth mapping;
mapping a second combination of processes across the memory-device addresses using the third and fourth mappings;
measuring third and fourth performance metrics associated with the second combination of processes and the respective third and fourth mappings; and
selecting between the third and fourth mappings based upon the third and fourth performance metrics.

14. The method of claim 13, further comprising correlating the first combination with the selected one of the first and second mappings and the second combination with the selected one of the third and fourth mappings and storing the correlations.

15. The method of claim 14, further comprising, subsequent to selecting between the first and second and the third and fourth mappings, activating the first combination of processes across the memory-device addresses and choosing between the selected one of the first and second mappings based on the activating of the first combination of processes.

16. A memory controller comprising:
an interface to provide memory commands and memory-device addresses directing data communication with a memory device;
circuitry to derive efficiency measures from the commands and data communication; and
mapping logic coupled to the circuit, the mapping logic to provide alternative address mappings between a physical-address field and the memory-device addresses responsive to the efficiency measures derived by the circuitry.

17. The controller of claim 16, wherein the efficiency measures include a ratio of activate commands to memory transactions involving the memory device.

18. The controller of claim 16, further comprising virtual-to-physical address translation logic to translate virtual addresses to physical addresses in the physical-address field.

19. The controller of claim 18, wherein the address translation logic copies portions of the virtual addresses into a subfield of the physical-address field.

20. The controller of claim 19, wherein the alternative mappings apply only to the subset of the physical-address field.

21. The controller of claim 16, wherein the memory-device addresses are a subset of a total number of available memory-device addresses, and wherein the alternative mappings apply only to the subset of the total number.

22. A method of operation in a memory controller, the method comprising:
relating a physical-address field to memory-device addresses using a first mapping for a mapped subset of memory rows;
executing a thread in the memory device using the first mapping, wherein the executing produces a first proportion of row hits;
relating the physical-address field to the memory-device addresses using a second mapping for the mapped subset of the memory rows;
executing the thread in the memory device using the second mapping, wherein the executing produces a second proportion of row hits; and
selecting, as an optimal mapping, the one of the first and second mappings that provides the lower of the first and second proportions of row hits.

23. The method of claim 22, further storing the optimal mapping in non-volatile memory.

24. The method of claim 23, further comprising, responsive to a command to execute the thread, reading the optimal mapping from the non-volatile memory and executing the thread in the memory device using the optimal mapping.

25. The method of claim 22, wherein selecting the optimal mapping comprises executing memory transactions and calculating an average number of wait cycles per transaction.
